(19) United States
(12) Patent Application Publication
(10) Pub. No.: US 2023/0298801 A1
(43) Pub. Date: Sep. 21, 2023

(54) REACTOR, CONVERTER, AND POWER CONVERSION DEVICE

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Masaya MURASHITA, Mie (JP); Kazuhiro INABA, Mie (JP); Kohei YOSHIKAWA, Mie (JP)

(21) Appl. No.: 18/021,057

(22) PCT Filed: Aug. 2, 2021
(86) PCT No.: PCT/JP2021/028621

§ 371 Date: Feb. 13, 2023

(30) Foreign Application Priority Data
Aug. 24, 2020 (JP) 2020-141155

(51) Int. Cl. H01F 27/255; H01F 37/00; H01F 1/20; H01F 27/30

(52) U.S. Cl. CPC H01F 27/255; H01F 37/00; H01F 1/20; H01F 27/306

(57) ABSTRACT

A reactor is provided with a coil and a magnetic core. The magnetic core includes a first core and a second core formed into a θ shape by being combined in an X direction. The first core includes a first end core part, at least a part of a middle core part, at least parts of both side core parts including a first side core part and a second side core part. The second core includes a second end core part, a remaining part of the middle core part and remaining parts of the first and second side core parts. A relative magnetic permeability of the second core is higher than that of the first core. Each of the first and second side core parts of the first core has a tip surface. A surface of the second core has facing surfaces facing the tip surfaces.

### TECHNICAL FIELD

The present disclosure relates to a reactor, a converter, and a power conversion device.

This application claims a priority based on Japanese Patent Application No. 2020-141155 filed on Aug. 24, 2020, all the contents of which are hereby incorporated by reference.

### BACKGROUND

Constituent components of a converter to be installed in a vehicle such as a hybrid or electric vehicle include a reactor. The reactor is provided with a coil and a magnetic core. FIGS. 5 to 8 of patent literature 1 show a reactor provided with one coil and a magnetic core formed by combining two E-shaped core pieces. This magnetic core is a so-called E-E type core. This magnetic core is formed into a θ shape by combining the both core pieces such that end surfaces of the core pieces are facing each other. The magnetic core includes end core parts, a middle core part and side core parts. The end core parts are arranged on end surface sides of the coil to sandwich the coil in an axial direction. The middle core part is arranged inside the coil. The side core parts are arranged outside the coil to sandwich the middle core part.

### PRIOR ART DOCUMENT

### Patent Document

Patent Document 1: JP 2016-201509 A

### SUMMARY OF THE INVENTION

A reactor of the present disclosure includes a coil and a magnetic core, the magnetic core including a first core and a second core formed into a θ shape by being combined in an X direction, the first core including a first end core part, at least a part of a middle core part and at least parts of both side core parts including a first side core part and a second side core part, the second core including a second end core part, a remaining part of the middle core part and remaining parts of the first and second side core parts, the first end core part facing a first end surface of the coil, the second end core part facing a second end surface of the coil, the middle core part being arranged inside the coil, the first and second side core parts being arranged outside the coil to sandwich the middle core part, a relative magnetic permeability of the second core being higher than that of the first core, each of the first and second side core parts of the first core having a tip surface facing the second core, a surface of the second core having facing surfaces facing the tip surfaces, an outer side edge of the facing surface being located inwardly of that of the tip surface in a Y direction and an inner side edge of the facing surface and that of the tip surface being substantially aligned in the Y direction when the magnetic core is viewed from a Z direction, a width in the Y direction of the facing surface being shorter than that of the tip surface, the X direction being a direction along an axial direction of the middle core part, the Y direction being a parallel direction of the middle core part, the first side core part and the second side core part, and the Z direction being a direction orthogonal to both the X direction and the Y direction.

A converter of the present disclosure includes the reactor of the present disclosure.

A power conversion device of the present disclosure includes the converter of the present disclosure.

### BRIEF DESCRIPTION OF THE DRAWINGS

FIG. 1 is a perspective view showing an outline of an entire reactor according to a first embodiment.

FIG. 2 is a perspective view showing an outline of the reactor according to the first embodiment in a disassembled state.

FIG. 3 is a top view showing the outline of the entire reactor according to the first embodiment.

FIG. 4 is an enlarged view showing a positional relationship of a tip surface of a first core and a facing surface of a second core in a magnetic core provided in the reactor according to the first embodiment.

FIG. 5 is a top view showing an outline of an entire reactor according to a second embodiment.

FIG. 6 is a top view showing an outline of an entire reactor according to a third embodiment.

FIG. 7 is an enlarged view showing a positional relationship of a tip surface of a first core and a facing surface of a second core in a magnetic core provided in the reactor according to the third embodiment.

FIG. 8 is a top view showing an outline of an entire reactor according to a fourth embodiment.

FIG. 9 is a configuration diagram schematically showing a power supply system of a hybrid vehicle.

FIG. 10 is a circuit diagram showing an outline of an example of a power conversion device provided with a converter.

FIG. 11 is a graph showing an inductance analysis result in Test Example 1.

### TECHNICAL PROBLEM

In terms of reducing the weight of a reactor, a weight reduction of a magnetic core is required.

Generally, in an E-E type magnetic core, two E-shaped core pieces are symmetrically arranged. The both core pieces are made of the same material and have the same shape and size. If the entire magnetic core is reduced in size, specifically, if the both core pieces are reduced in size for the weight reduction of the magnetic core, electromagnetic performance of a reactor may be affected. Further, if the entire magnetic core is reduced in size, there is a concern for a loss increase. Therefore, it is desired to realize the weight reduction of the magnetic core while maintaining the electromagnetic performance. An inductance can be, for example, cited as the electromagnetic performance.

Accordingly, one object of the present disclosure is to provide a reactor which can be reduced in weight. Another object of the present disclosure is to provide a converter provided with the above reactor. Still another object of the present disclosure is to provide a power conversion device provided with the above converter.

### Effect of Present Disclosure

The reactor of the present disclosure can be reduced in weight. Further, the converter and the power conversion device of the present disclosure can be reduced in weight.

### DESCRIPTION OF EMBODIMENTS OF PRESENT DISCLOSURE

First, embodiments of the present disclosure are listed and described.
(1) A reactor according to an embodiment of the present disclosure includes a coil and a magnetic core, the magnetic core including a first core and a second core formed into a θ shape by being combined in an X direction, the first core including a first end core part, at least a part of a middle core part and at least parts of both side core parts including a first side core part and a second side core part, the second core including a second end core part, a remaining part of the middle core part and remaining parts of the first and second side core parts, the first end core part facing a first end surface of the coil, the second end core part facing a second end surface of the coil, the middle core part being arranged inside the coil, the first and second side core parts being arranged outside the coil to sandwich the middle core part, a relative magnetic permeability of the second core being higher than that of the first core, each of the first and second side core parts of the first core having a tip surface facing the second core, a surface of the second core having facing surfaces facing the tip surfaces, an outer side edge of the facing surface being located inwardly of that of the tip surface in a Y direction and an inner side edge of the facing surface and that of the tip surface being substantially aligned in the Y direction when the magnetic core is viewed from a Z direction, a width in the Y direction of the facing surface being shorter than that of the tip surface, the X direction being a direction along an axial direction of the middle core part, the Y direction being a parallel direction of the middle core part, the first side core part and the second side core part, and the Z direction being a direction orthogonal to both the X direction and the Y direction.

The reactor can be reduced in weight. The reason for that is that the volume of the second core can be made smaller than that of a comparison core. The comparison core means a core having the same specifications as the second core of the reactor except that the outer side edges of the facing surfaces and those of the tip surfaces are aligned in the Y direction. The tip surfaces are end surfaces in the X direction of the first and second side core parts of the first core. The facing surfaces are surfaces facing the tip surfaces of the first core, out of the surface of the second core. The tip surface of the first core is in contact with at least a partial region of the facing surface of the second core. In the reactor, the width of the facing surface of the second core is shorter than that of the tip surface of the first core. Further, the tip surface of the first core and the facing surface of the second core are in such a positional relationship that the outer side edge of the facing surface is located inwardly of that of the tip surface in the Y direction and the inner side edge of the facing surface and that of the tip surface are substantially aligned in the Y direction. If the tip surface and the facing surface satisfy the above positional relationship, an outer width of the second core is narrower than that of the first core, whereby the volume of the second core can be reduced. Thus, the weight of the second core is reduced, wherefore the magnetic core can be reduced in weight. The width of the tip surface or that of the facing surface is a length of the corresponding surface along the Y direction, and equal to a distance in the Y direction between the outer and inner side edges of the tip surface or facing surface. An outer width of the first core or that of the second core is a maximum length along the Y direction of the first or second core. The outer width of the first core or that of the second core is typically a width, i.e. a length along the Y direction, of the first or second end core part.

The reactor can maintain electromagnetic performance even if the width of the facing surface of the second core is shorter than that of the tip surface of the first core. This is because, in the reactor, the first and second cores have different magnetic properties, specifically, the relative magnetic permeability of the second core is higher than that of the first core. If the width of the facing surface of the second core is shorter than that of the tip surface of the first core, a magnetic path area of the magnetic core is locally reduced in a contact part of the tip surface and the facing surface. Since the respective relative magnetic permeabilities of the second and first cores satisfy the above relationship, a magnetic flux which can pass between the tip surface and the facing surface is easily balanced. In other words, a balance of the magnetic flux can be substantially maintained between the first and second cores. If the first and second cores have the same relative magnetic permeability, but an area of the facing surface is smaller than that of the tip surface, the magnetic flux flowing in the second core becomes smaller than that flowing in the first core near the contact part of the tip surface and the facing surface. If the first and second cores have different relative magnetic permeabilities although the area of the facing surface is smaller than that of the tip surface, an influence on the magnetic flux flowing in the first and second cores is minor if the magnetic flux is in a substantially balanced range. Thus, due to a high relative magnetic permeability of the second core, the width of the facing surface of the second core can be made shorter while the electromagnetic performance such as an inductance is maintained.
(2) As one aspect of the reactor, the width in the Y direction of the facing surface is 60% or more and 92% or less of that of the tip surface.

In this aspect, a weight reduction is easily realized while the magnetic performance is maintained. The magnetic performance can be maintained since the contact area of the tip surface and the facing surface is easily secured by the width of the facing surface being 60% or more of that of the tip surface. By securing the contact area of the tip surface and the first core, the magnetic flux is easily balanced between the tip surface and the facing surface. That is, since a balance of the magnetic flux can be substantially maintained between the first and second cores, the magnetic performance such as an inductance is easily maintained. The weight reduction can be realized since the width of the facing surface is sufficiently short by being set to 92% or less of the width of the tip surface. Since the width of the facing surface is sufficiently short, the weight of the second core can be effectively reduced.
(3) As one aspect of the reactor, the first core is a compact of a composite material, a soft magnetic powder being dispersed in a resin in the composite material, and the second core is a powder compact made of a raw powder containing a soft magnetic powder.

In this aspect, a predetermined inductance is easily obtained. This is because magnetic properties of the entire magnetic core can be adjusted by the magnetic core including the compact of the composite material having a lower relative magnetic permeability than the powder compact. Further, in this aspect, the magnetic properties of the entire magnetic core can be adjusted even if the magnetic core is not provided with a gap part. Since it is not necessary to provide the magnetic core with the gap part, a leakage magnetic flux from the gap part can be suppressed. Thus, a loss due to the leakage magnetic flux can be reduced. Further, if the first core is constituted by the compact of the composite material and the second core is constituted by the powder compact, the respective relative magnetic permeabilities of the first and second cores easily satisfy the above relationship.
(4) As one aspect of the reactor, the relative magnetic permeability of the first core is 5 or more and 50 or less.

In this aspect, the predetermined inductance is easily obtained.
(5) As one aspect of the reactor, the relative magnetic permeability of the second core is 50 or more and 500 or less.

In this aspect, the predetermined inductance is easily obtained.
(6) As one aspect of the reactor, a ratio of the relative magnetic permeability of the second core to that of the first core is 1.1 or more and 12 or less.

In this aspect, the weight reduction is easily realized while the magnetic performance is maintained. This is because the width of the facing surface can be made sufficiently shorter than that of the tip surface by having the relative magnetic permeability ratio of 1.1 or more. Further, if the relative magnetic permeability ratio is 12 or less, the predetermined inductance is easily obtained.
(7) As one aspect of the reactor, {(μr₁×Ws₁)/(μr₂×Ws₂)} satisfies a condition of being 0.1 or more and 1.6 or less, where μs₁ denotes the relative magnetic permeability of the first core, Ws₁ denotes the width in the Y direction of the tip surface, μs₂ denotes the relative magnetic permeability of the second core and Ws₂ denotes the width in the Y direction of the facing surface.

In this aspect, a reduction in the magnetic performance can be efficiently suppressed. This is because a magnetic flux which can pass between the tip surface and the facing surface can be set in a substantially balanced range by the relative magnetic permeability of the first core and the width of the tip surface, and the relative magnetic permeability of the second core and the width of the facing surface satisfying the above relational expression. Since a balance of the magnetic flux can be substantially maintained between the first and second cores, a reduction in the magnetic performance such as an inductance can be suppressed.
(8) As one aspect of the reactor, the first core includes each of the first and second side core parts entirely, and the facing surfaces are provided on the second end core part of the second core.

In this aspect, the magnetic core of an E-T type or E-I type is typically obtained. In this aspect, the width of the second end core part of the second core is shorter than that of the first end core part of the first core. The width of each end core part is a width in the Y direction of each end core part.
(9) As one aspect of the reactor, the first core includes a part of each of the first and second side core parts, and the facing surface is provided on the remaining part of each of the first and second side core parts of the second core.

In this aspect, the magnetic core of an E-E type or E-U type is typically obtained. In this aspect, the width of the remaining part of each of the first and second side core parts of the second core is shorter than that of the remaining part of each of the first and second side core parts of the first core. The width of the part of each side core part is a width in the Y direction of each part. The width of the remaining part of each side core part is a width in the Y direction of each remaining part.
(10) A converter according to an embodiment of the present disclosure includes the reactor of any one of (1) to (9) described above.

The converter can be reduced in weight since including the above reactor.
(11) A power conversion device according to an embodiment of the present disclosure includes the converter of (10) described above.

The power conversion device can be reduced in weight since including the above converter.

### DETAILS OF EMBODIMENTS OF PRESENT DISCLOSURE

Specific embodiments of the present disclosure are described in detail below with reference to the drawings. The same reference signs in figures denote the same components. Note that the present invention is not limited to these illustrations and is represented by claims and intended to include all changes in the scope of claims and in the meaning and scope of equivalents.

### FIRST EMBODIMENT

[Reactor]

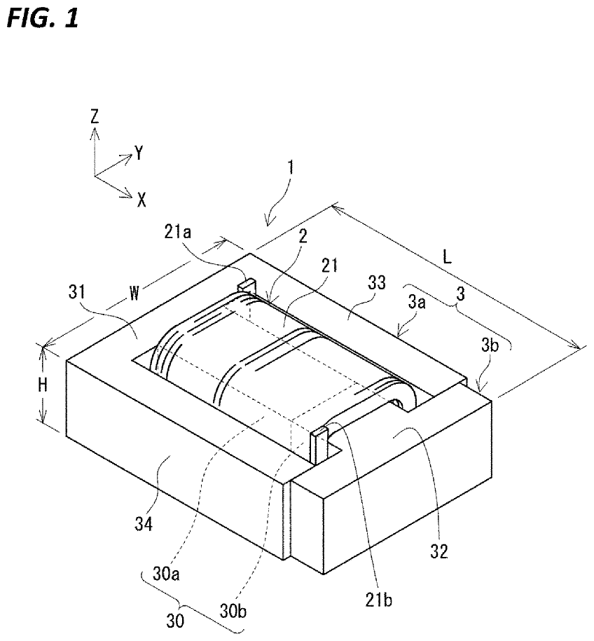

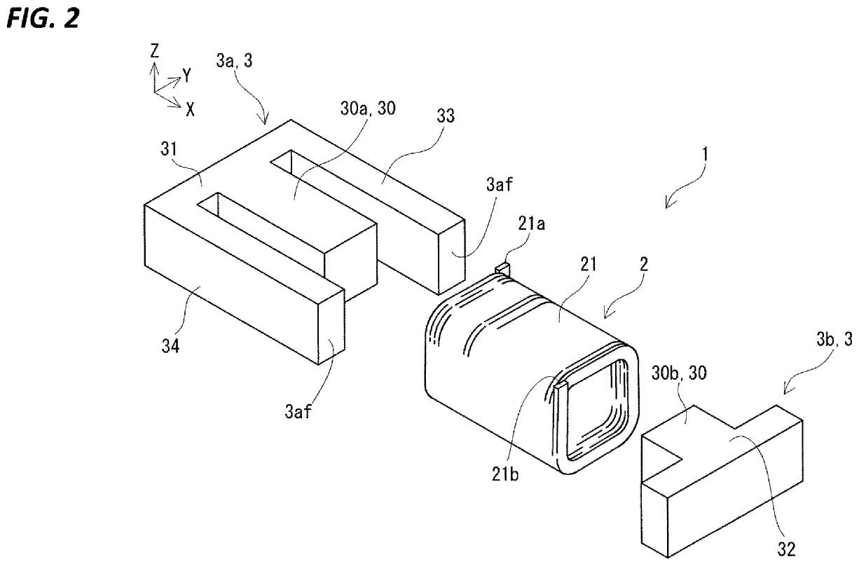

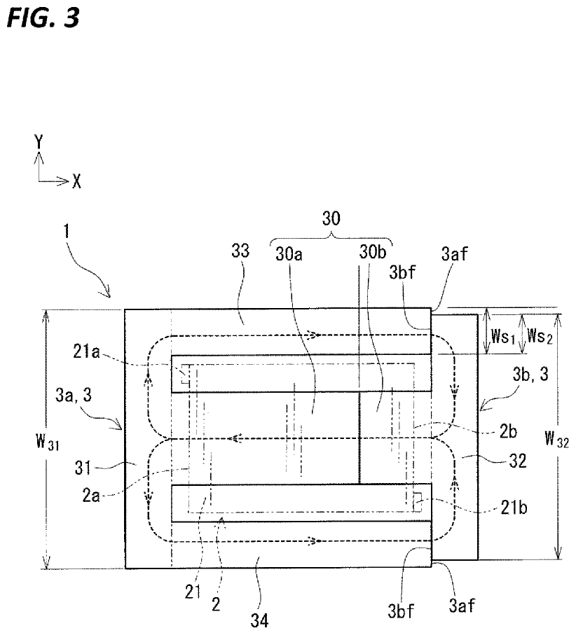

A reactor 1 of a first embodiment is described with reference to FIGS. 1 to 4. As shown in FIGS. 1 and 2, the reactor 1 includes a coil 2 and a magnetic core 3. The magnetic core 3 includes a first core 3a and a second core 3b. As shown in FIG. 3, the magnetic core 3 is formed into a θ shape as a whole by combining the first and second cores 3a, 3b. The first core 3a has tip surfaces 3af to be described later. The second core 3b has facing surfaces 3bf facing the tip surfaces 3af.

One of features of the reactor 1 of this embodiment is to satisfy the following requirements (a) to (c).
(a) A relative magnetic permeability of the second core 3b is higher than that of the first core 3a.
(b) The tip surface 3af of the first core 3a and the facing surface 3bf of the second core 3b are in a specific positional relationship.
(c) A width Ws₂ of the facing surface 3bf is shorter than a width Ws₁ of the tip surface 3af.

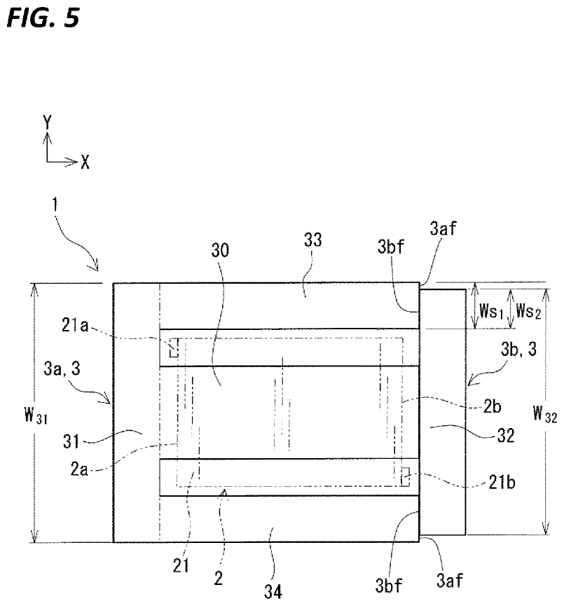

The configuration of the reactor 1 is described in detail below. The coil 2 is shown by a two-dot chain line for the convenience of description in FIG. 3. This point applies also to FIGS. 5, 6, and 8 respectively referred to in second to fourth embodiments to be described later.

(Coil)

As shown in FIGS. 1 and 2, the coil 2 includes one winding portion. The winding portion 21 is formed by spirally winding a winding wire. A known winding wire can be used as the winding wire. In this embodiment, the winding wire is a coated rectangular wire. A conductor of the winding wire is constituted by a rectangular wire made of copper. An insulation coating of the coated rectangular wire is made of enamel. The coil 2 is an edgewise coil formed by winding the coated rectangular wire in an edgewise manner.

The winding portion 21 of this embodiment has a rectangular tub shape. Rectangular shapes include square shapes. That is, the end surface shape of the winding portion 21 is a rectangular frame shape. The winding portion 21 may have a hollow cylindrical shape. Since the winding portion 21 has a rectangular tube shape, a contact area of the winding portion 21 and an installation target is easily increased as compared to the case where the winding portion 21 has a cylindrical tube shape having the same inner area. The inner area is an opening area of a space surrounded by the inner periphery of the winding portion 21. Since the contact area is increased, heat is easily dissipated to the installation target via the winding portion 21. Moreover, the winding portion 21 is easily disposed on the installation target. Corner parts of the winding portion 21 are rounded.

An end part 21a and an end part 21b of the winding portion 21 are respectively pulled out to an outer peripheral side of the winding portion 21 on one and the other end sides in an axial direction of the winding portion 21. The insulation coating is stripped to expose the conductor in the first and second end parts 21a, 21b of the winding portion 21. Unillustrated terminal members are attached to the end parts 21a, 21b. An external device is connected to the coil 2 via these terminal members. The external device is not shown. A power supply for supplying power to the coil 2 can be cited as the external device.

(Magnetic Core)

As shown in FIG. 3, the magnetic core 3 includes a middle core part 30, a first end core part 31, a second end core part 32, a first side core part 33 and a second side core part 34. In FIG. 3, a boundary of each core part is shown by a two-dot chain line. This point applies also to FIGS. 5, 6, and 8 respectively referred to in the second to fourth embodiments to be described later. In this embodiment, an X direction, a Y direction and a Z direction are defined as follows. The X direction is a direction along an axial direction of the middle core part 30. The Y direction is a direction orthogonal to the X direction and is a parallel direction of the middle core part 30 and the first and second side core parts 33, 34. The Z direction is a direction orthogonal to both the X direction and Y direction. The X direction is equivalent to a length direction. The Y direction is equivalent to a width direction. The Z direction is equivalent to a height direction.

The magnetic core 3 has a θ shape when viewed from the Z direction as shown in FIG. 3. If the coil 2 is energized, a magnetic flux flows in the magnetic core 3 to form a θ-shaped closed magnetic path. In FIG. 3, thick broken-line arrows indicate flows of the magnetic flux. A flowing direction of the magnetic flux may be opposite to the one indicated by the above arrows shown in FIG. 3. The magnetic flux generated by the coil 2 flows from the middle core part 30 through the first end core part 31, the first and second side core parts 33, 34 and the second end core part 32 and returns to the middle core part 30. That is, two annular closed magnetic paths respectively passing through the first and second side core parts 33, 34 are formed in the magnetic core 3.

<Middle Core Part>

The middle core part 30 is a part of the magnetic core 3 to be arranged inside the coil 2. In this embodiment, both end parts in the X direction of the middle core part 30 project from both end surfaces 2a, 2b of the coil 2. These projecting parts are also parts of the middle core part 30.

The shape of the middle core part 30 is not particularly limited as long as corresponding to the inner shape of the winding portion 21. As shown in FIG. 2, the middle core part 30 of this embodiment has a substantially rectangular parallelepiped shape. When viewed from the X direction, corner parts of the middle core part 30 may be rounded to extend along the inner peripheral surfaces of the corner parts of the winding portion 21.

The middle core part 30 may be divided or may not be divided in the X direction. The middle core part 30 of this embodiment is divided into two in the X direction and includes a first middle core part 30a and a second middle core part 30b. The first middle core part 30a is located on one side in the X direction of the middle core part 30, specifically, on the side of the first end core part 31. The second middle core part 30b is located on the other side in the X direction of the middle core part 30, specifically, on the side of the second end core part 32. In this embodiment, the first and second middle core parts 30a, 30b are in contact and there is substantially no clearance between the first and second middle core parts 30a, 30b. That is, the middle core part 30 includes no gap part between the first and second middle core parts 30a, 30b. A length of each of the first and second middle core parts 30a, 30b may be appropriately set to obtain desired magnetic properties. The length mentioned here means a length in the X direction. The first middle core part 30a may be longer or shorter than the second middle core part 30b. In this embodiment, the first middle core part 30a is longer than the second middle core part 30b. The first and second middle core parts 30a, 30b have an equal width in the Y direction.

The middle core part 30 may include a gap part. The gap part may be provided between the first and second middle core parts 30a, 30b. The gap part is preferably positioned inside the winding portion 21. By locating the gap part inside the winding portion 21, a leakage magnetic flux from a gap 3g is easily suppressed. Thus, a loss due to the leakage magnetic flux is easily reduced. A length of the gap part may be appropriately set to obtain desired magnetic properties. The length of the gap part is, for example, 0.1 mm or more, further 0.3 mm or more. An upper limit of the length of the gap part is, for example, 2 mm or less, further 1.5 mm or less or 1.0 mm or less. The gap part may be an air gap or a non-magnetic body such as a resin or ceramic may be arranged as such.

<First End Core Part, Second End Core Part>

The first end core part 31 is a part of the magnetic core 3 facing the end surface 2a of the coil 2. The second end core part 32 is a part facing the end surface 2b of the coil 2. Here, facing means that the respective end core parts 31, 32 and the respective end surfaces 2a, 2b of the coil are facing each other. The first and second end core parts 31, 32 are arranged at an interval in the X direction to sandwich the both end surfaces 2a, 2b of the coil 2.

The shapes of the respective first and second end core parts 31, 32 are not particularly limited as long as predetermined magnetic paths are formed. As shown in FIG. 2, the both end core parts 31, 32 of this embodiment have a substantially rectangular parallelepiped shape.

<First Side Core Part, Second Side Core Part>

The first and second side core parts 33, 34 are parts of the magnetic core 3 to be arranged outside the coil 2 to sandwich the middle core part 30. That is, the first and second side core parts 33, 34 are arranged at an interval in the Y direction to sandwich both side surfaces along the axial direction of the coil 2. In this embodiment, out of the both side core parts 33, 34, the side core part arranged on one side in the Y direction, i.e. on an upper side, is referred to as the first side core part 33 and the side core part arranged on the other side in the Y direction, i.e. on a lower side, is referred to as the second side core part 34 when viewed from the Z direction as shown in FIG. 3. Axial directions of the respective first and second side core parts 33, 34 are parallel to the axial direction of the middle core part 30.

The first and second side core parts 33, 34 may have lengths to link the first and second end core parts 31, 32. The shapes of the respective side core parts 33, 34 are not particularly limited. As shown in FIG. 2, the both side core parts 33, 34 of this embodiment have a substantially rectangular parallelepiped shape. Lengths of the respective first and second side core parts 33, 34 may be equal or different. In this embodiment, the lengths of the respective first and second side core parts 33, 34 are equal to each other, and equal to the length of the middle core part 30. The length of the middle core part 30 is the sum of the lengths of the respective middle core parts 30a, 30b. If the middle core part 30 includes the gap part, the length of the middle core part 30 is the sum of the lengths of the respective middle core parts 30a, 30b excluding the gap part. The length of each of the middle core part 30 and the first and second side core parts 33, 34 is equal to a distance between mutually facing surfaces of the first and second end core parts 31, 32.

Widths in the Y direction of the respective first and second side core parts 33, 34 may be equal or different. In this embodiment, the respective widths of the first and second side core parts 33, 34 are equal. Further, the sum of the width of the first side core part 33 and that of the second side core part 34 is equal to the width of the middle core part 30. That is, the sum of a cross-sectional area of the first side core part 33 and that of the second side core part 34 is equal to a cross-sectional area of the middle core part 30.

At least one of the first and second side core parts 33, 34 may be divided or may not be divided in the X direction. Neither of the both side core parts 33, 34 of this embodiment is divided.

If the middle core part 30 includes the aforementioned gap part, the middle core part 30 is shorter than the both side core parts 33, 34. If the sum length of the first and second middle core parts 30a, 30b is shorter than the lengths of the respective side core parts 33, 34, a clearance serving as the gap part can be provided between the first and second middle core parts 30a, 30b.

(First Core, Second Core)

As shown in FIGS. 2 and 3, the magnetic core 3 is a set obtained by combining the first and second cores 3a, 3b. The magnetic core 3 is configured by combining the first and second cores 3a, 3b in the X direction. The respective shapes of the first and second cores 3a, 3b can be selected from various combinations. The magnetic core 3 of this embodiment is of an E-T type obtained by combining the E-shaped first core 3a and the T-shaped second core 3b.

<First Core>

The first core 3a may include the first end core part 31, at least a part of the middle core part 30 and at least parts of the both side core parts 33, 34 including the first side core part 33 and the second side core part 34. In this embodiment, as shown in FIG. 3, the first core 3a includes the entire first side core part 33 and the entire second side core part 34. Further, the first core 3a includes the first middle core part 30a, which is the part of the middle core part 30. The first end core part 31, the first middle core part 30a, the first side core part 33 and the second side core part 34 are integrally molded. The first middle core part 30a extends in the X direction from an intermediate part in the Y direction of the first end core part 31 toward the second middle core part 30b. The first and second side core parts 33, 34 extend in the X direction toward the second end core part 32 from both end parts in the Y direction of the first end core part 31. The first core 3a is E-shaped when viewed from the Z direction.

Each of the first and second side core parts 33, 34 of the first core 3a has the tip surface 3af facing the second core 3b as shown in FIG. 3. As shown in FIG. 2, the tip surface 3af has a rectangular shape when viewed from the X direction.

<Second Core>

The second core 3b may include the second end core part 32, a remaining part of the middle core part 30 and remaining parts of the first and second side core parts 33, 34. In this embodiment, as shown in FIG. 3, the second core 3b does not include the both side core parts 33, 34. The second core 3b includes the second middle core part 30b, which is the remaining part of the middle core part 30. The second end core part 32 and the second middle core part 30b are integrally molded. The second middle core part 30b extends in the X direction from an intermediate part in the Y direction of the second end core part 32 toward the first middle core part 30a. The second core 3b is T-shaped when viewed from the Z direction.

A surface of the second core 3b has the facing surfaces 3bf facing the tip surfaces 3af of the first core 3a in the X direction. That is, the facing surfaces 3bf are regions overlapping the tip surfaces 3af in the X direction, out of the surface of the second core 3b. In this embodiment, the facing surfaces 3bf are provided on the second end core part 32 of the second core 3b. The facing surface 3bf includes a contact region to be brought into contact with the tip surface 3af.

(Positional Relationship of Tip Surface and Facing Surface)

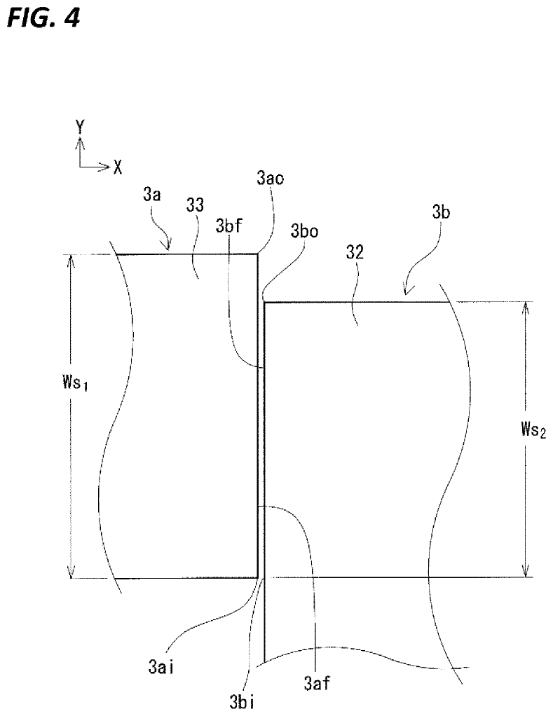

The tip surface 3af and the facing surface 3bf satisfy a specific positional relationship. Specifically, as shown in FIG. 4, an outer side edge 3bo of the facing surface 3bf is located inwardly of an outer side edge 3ao of the tip surface 3af in the Y direction, and an inner side edge 3bi of the facing surface 3bf and an inner side edge 3ai of the tip surface 3af are substantially aligned in the Y direction. FIG. 4 is an enlarged view showing the vicinity of the tip surface 3af and the facing surface 3bf on the side of the first side core part 33 when viewed from the Z direction. Although only the side of the first side core part 33 is shown in FIG. 4, the side of the second side core part 34 shown in FIG. 3 is also similarly configured. Further, although the tip surface 3af and the facing surface 3bf are shown to be separated for the convenience of description in FIG. 4, these surfaces are actually in contact with each other. The outer side edge mentioned here means an edge on an outer side in the Y direction. The inner side edge means an edge on an inner side in the Y direction. The outer side in the Y direction means a side away from the middle core part 30 in the Y direction. The inner side in the Y direction means a side near the middle core part 30 in the Y direction. The outer side edge 3ao of the tip surface 3af or the outer side edge 3bo of the facing surface 3bf is an edge distant from the middle core part 30 (FIG. 3) when viewed from the Z direction, out of edges constituting the tip surface 3af or facing surface 3bf. The inner side edge 3ai of the tip surface 3af or the inner side edge 3bi of the facing surface 3bf is an edge near the middle core part 30 (FIG. 3) when viewed from the Z direction, out of the edges constituting the tip surface 3af or facing surface 3bf. That “the outer side edge 3bo of the facing surface 3bf is located inwardly of the outer side edge 3ao of the tip surface 3af in the Y direction” means that the outer side edges 3bo, 3ao are not aligned in the Y direction and the outer side edge 3bo is shifted inwardly in the Y direction from the outer side edge 3ao when viewed from the Z direction. That “the inner side edge 3bi of the facing surface 3bf and the inner side edge 3ai of the tip surface 3af are substantially aligned” means that a deviation in the Y direction between the inner side edges 3bi and 3ai is 10% or less, further 5% or less of the width Ws₁ of the tip surface 3af. If the second end core part 32 has the facing surface 3bf as in this embodiment, the inner side edge 3bi of the facing surface 3bf is located on an extension of the inner side edge 3ai of the tip surface 3af in the X direction as shown in FIG. 4. Thus, the inner side edges 3bi, 3ai are not shifted in the Y direction and are aligned in the Y direction. That is, when viewed from the Z direction, the positions of the inner side edges 3bi and 3ai in the Y direction coincide.

(Width Relationship of Facing Surface and Tip Surface)

The width Ws₂ of the facing surface 3bf is shorter than the width Ws₁ of the tip surface 3af. The width mentioned here means a width in the Y direction. Since the width Ws₂ of the facing surface 3bf is shorter than the width Ws₁ of the tip surface 3af, the volume of the second core 3b is reduced as compared to the case where width Ws₂ of the facing surface 3bf and the width Ws₁ of the tip surface 3af are equal. Thus, the weight of the second core 3b is reduced, wherefore the magnetic core 3 can be reduced in weight. In this embodiment, when viewed from the Z direction as shown in FIG. 3, outer parts in the Y direction of the both side core parts 33, 34 project further outward than the second end core part 32. Thus, a width W₃₂ of the second end core part 32 is shorter than a width W₃₁ of the first end core part 31.

The width Ws₂ of the facing surface 3bf is, for example, 60% or more and 92% or less, further 65% or more and 90% or less, or 70% or more and 85% or less of the width Ws₁ of the tip surface 3af. Since the width Ws₂ of the facing surface 3bf is 60% or more of the width Ws₁ of the tip surface 3af, a contact area of the tip surface 3af and the facing surface 3bf is easily secured. By securing the contact area of the tip surface 3af and the facing surface 3bf, a magnetic flux which can pass between the tip surface 3af and the facing surface 3bf is easily set in a substantially balanced range. Within the range in which the magnetic flux is substantially balanced, a balance of the magnetic flux can be substantially maintained between the first and second cores 3a, 3b when magnetic paths are formed in the magnetic core 3. Thus, electromagnetic performance such as an inductance can be maintained. Since the width Ws₂ of the facing surface 3bf is 92% or less of the width Ws₁ of the tip surface 3af, the width Ws₂ of the facing surface 3bf is sufficiently short. Thus, the weight of the second core 3b can be effectively reduced.

(Relative Magnetic Permeability Relationship of First and Second Cores)

The first and second cores 3a, 3b have different relative magnetic permeabilities. Specifically, the relative magnetic permeability of the second core 3b is higher than that of the first core 3a. That is, if μs₁ denotes the relative magnetic permeability of the first core 3a and μs₂ denotes the relative magnetic permeability of the second core 3b, a relationship of μs₁<μs₂ is satisfied. Since the relative magnetic permeability of the second core 3b is higher than that of the first core 3a, the magnetic flux is easily balanced between the tip surface 3af and the facing surface 3bf even if the width Ws₂ of the facing surface 3bf is shorter than the width Ws₁ of the tip surface 3af. Thus, a balance of the magnetic flux can be substantially maintained between the first and second cores 3a, 3b. Therefore, the width Ws₂ of the facing surface 3bf can be made shorter than the width Ws₁ of the tip surface 3af while the electromagnetic performance such as an inductance is maintained.

The relative magnetic permeability of the first core 3a is, for example, 5 or more and 50 or less. The relative magnetic permeability of the second core 3b is, for example, 50 or more and 500 or less. The relative magnetic permeability of each of the first and second cores 3a, 3b can be appropriately set after satisfying the above relative magnetic permeability relationship. If the respective relative magnetic permeabilities of the first and second cores 3a, 3b are within the respective ranges, a predetermined inductance is easily obtained. The relative magnetic permeability of the first core 3a may be further 10 or more and 45 or less, or 15 or more and 40 or less. The relative magnetic permeability of the second core 3b may be further 100 or more, or 150 or more.

Further, a ratio of the relative magnetic permeability of the second core 3b to that of the first core 3a is preferably 1.1 or more and 12 or less. That is, a relationship of 1.1≤μr₂/μr₁≤12 is satisfied. If the relative magnetic permeability ratio is 1.1 or more, the relative magnetic permeability of the second core 3b is sufficiently higher than that of the first core 3a. Thus, the width Ws₂ of the facing surface 3bf can be made sufficiently shorter than the width Ws₁ of the tip surface 3af. If the relative magnetic permeability ratio is 12 or less, a predetermined inductance is easily obtained. The relative magnetic permeability ratio may be further 1.5 or more, 2 or more, or 2.5 or more.

The relative magnetic permeability can be obtained as follows. Ring-shaped measurement samples are cut out respectively from the first and second cores 3a, 3b. Primary winding: 300 turns and secondary winding: 20 turns are applied to each of the measurement samples. A B-H initial magnetization curve is measured in a range of H=0 (Oe) or more and 100 (Oe) or less, and a maximum value of a gradient of this B-H initial magnetization curve is obtained. This maximum value is set as a relative magnetic permeability. The magnetization curve mentioned here is a so-called direct-current magnetization curve.

(Materials)

The first and second cores 3a, 3b are constituted by compacts. Powder compacts, compacts of composite materials and the like can be, for example, cited as the compacts. The first and second cores 3a, 3b are compacts made of mutually different materials. The mutually different materials mean not only a case where materials of individual constituent elements of the respective compacts constituting the first and second cores 3a, 3b are different, but also a case where contents of the respective constituent elements are different even if the materials of the respective constituent elements are the same. For example, even if the first and second cores 3a, 3b are constituted by powder compacts, these cores 3a, 3b are made of mutually different materials if the materials and contents of soft magnetic powders constituting the powder compacts are different. Further, even if the first and second cores 3a, 3b are constituted by compacts of composite materials, these cores 3a, 3b are made of mutually different materials if the materials and contents of soft magnetic powders constituting the composite materials are different.

The powder compact is obtained by compression-forming a raw powder containing a soft magnetic powder. The powder compact has a higher content of the soft magnetic powder as compared to composite materials. Thus, the powder compact easily enhances magnetic properties. A relative magnetic permeability and a saturated magnetic flux density can be cited as the magnetic properties. The powder compact may contain a binder resin, a molding aid and the like. A content of the magnetic powder in the powder compact is, for example, 85% by volume or more and 99.99% by volume or less if the powder compact is 100% by volume.

In the composite material, the soft magnetic powder is dispersed in the resin. The compact of the composite material is obtained by filling a fluid raw material, in which the soft magnetic powder is dispersed in the uncured resin, into a mold and solidifying the resin. The composite material can easily adjust a content of the soft magnetic powder in the resin. Thus, the composite material easily adjusts magnetic properties. A content of the soft magnetic powder in the composite material is, for example, 20% by volume or more and 80% by volume or less if the composite material is 100% by volume.

Particles of soft magnetic metals, coated particles including insulation coatings on the outer peripheries of particles of soft magnetic metals, particles of soft magnetic nonmetals and the like can be cited as particles constituting the soft magnetic powder. Pure iron and iron-based alloys can be cited as the soft magnetic metal. Fe (iron)-Si (silicon) alloys, Fe—Ni (nickel) alloys and the like can be cited as the iron-based alloys. Phosphates and the like can be cited as materials of the insulation coatings. Ferrite and the like can be cited as the soft magnetic nonmetals.

Thermosetting resins and thermoplastic resins can be, for example, cited as the resin of the composite material. An unsaturated polyester resin, an epoxy resin, a urethane resin, a silicone resin and the like can be, for example, cited as the thermosetting resins. A polyphenylene sulfide resin, a polytetrafluoroethylene resin, a liquid crystal polymer, a polyamide resin, a polybutylene terephthalate resin, an acrylonitrile-butadiene-styrene resin and the like can be cited as the thermoplastic resins. Nylon 6, nylon 66, nylon 9T and the like can be cited as the polyimide resin. Besides, a BMC (Bulk Molding Compound) in which calcium carbonate and a glass fiber are mixed in an unsaturated polyester, millable type silicone rubber, millable type urethane rubber and the like can also be used.

The composite material may contain a filler in addition to the soft magnetic powder and the resin. Ceramic fillers such as alumina and silica can be, for example, cited as the filler. By containing the filler in the composite material, heat dissipation can be enhanced. A content of the filler is 0.2% by mass or more and 20% by mass or less, further 0.3% by mass or more and 15% by mass or less, or 0.5% by mass or more and 10% by mass or less when the composite material is 100% by volume.

The content of the soft magnetic powder in the powder compact or the compact of the composite material is regarded as equivalent to an area ratio of the soft magnetic powder in a cross-section of the compact. The content of the soft magnetic powder is obtained as follows. An observation image is obtained by observing the cross-section of the compact by a SEM (Scanning Electron Microscope). A magnification of the SEM is, for example, 200× or more and 500× or less. 10 or more observation images are obtained. A total cross-sectional area is 0.1 cm² or more. One observation image may be obtained for one cross-section or a plurality of observation images may be obtained for one cross-section. An image processing is applied to each obtained observation image and the contours of the particles are extracted. A binarization processing can be, for example, cited as the image processing. An area ratio of the soft magnetic particles is calculated in each observation image and an average value of the area ratios is obtained. That average value is regarded as the content of the soft magnetic powder.

In this embodiment, the first core 3a is constituted by a compact of a composite material, and the second core 3b is constituted by a powder compact. By constituting the first core 3a by the compact of the composite material and constituting the second core 3b by the powder compact, magnetic properties of the entire magnetic core 3 can be adjusted. Thus, a predetermined inductance is easily obtained even if the magnetic core 3 is not provided with the gap part as in this embodiment. Even if the first and second cores 3a, 3b are made of mutually different materials, the gap part may be provided if necessary. Further, if the first core 3a is constituted by the compact of the composite material and the second core 3b is constituted by the powder compact, the respective relative magnetic permeabilities of the first and second cores 3a, 3b easily satisfy the above relationship. In this embodiment, the relative magnetic permeability of the first core 3a is 20 and that of the second core 3b is 150.

(Relationship of Relative Magnetic Permeability and Tip Surface Width of First Core and Relative Magnetic Permeability and Facing Surface Width of Second Core)

If μs₁ denotes the relative magnetic permeability of the first core 3a, Ws₁ denotes the width of the tip surface 3af, μs₂ denotes the relative magnetic permeability of the second core 3b and Ws₂ denotes the width of the facing surface 3bf, {(μr₁×Ws₁)/(μr₂×Ws₂)} preferably satisfies a condition of being 0.1 or more and 1.6 or less. If the relative magnetic permeability μs₁ and the width Ws₁, and the relative magnetic permeability μs₂ and the width Ws₂ satisfy the above relational expression, a magnetic flux which can pass between the tip surface 3af and the facing surface 3bf can be set in a substantially balanced range. If {(μr₁×Ws₁)/(μr₂×Ws₂)} is 0.1 or more and 1.6 or less, a balance of the magnetic flux can be substantially maintained between the first and second cores 3a, 3b since the magnetic flux is in the substantially balanced range. Therefore, a reduction in inductance can be effectively suppressed. {(μr₁×Ws₁)/(μr₂×Ws₂)} may be further 0.1 or more and 1.4 or less, or 0.15 or more or 1.2 or less.

(Size)

For example, if the reactor 1 is for vehicle, the size of the magnetic core 3 is as follows as shown in FIG. 1. A length L in the X direction of the magnetic core 3 is, for example, 30 mm or more and 150 mm or less. A width W in the Y direction of the magnetic core 3 is, for example, 30 mm or more and 150 mm or less. A height H in the Z direction of the magnetic core 3 is, for example, 15 mm or more and 75 mm or less. The width W of the magnetic core 3 is equivalent to the width W₃₁ of the first end core part 31. The width W₃₂ of the second end core part 32 is shorter than the width W₃₁ of the first end core part 31. Specifically, the width W₃₂ of the second end core part 32 is shorter than the width W₃₁ of the first end core part 31 by width differences between the tip surfaces 3af and the facing surfaces 3bf.

Further, the sizes of main parts of the magnetic core 3 are as follows. A width of the middle core part 30, i.e. widths of the first and second middle core parts 30a, 30b, is, for example, 10 mm or more and 50 mm or less. Lengths of the first and second end core parts 31, 32 are, for example, 5 mm or more and 40 mm or less. Widths of the first and second side core parts 33, 34 are, for example, 5 mm or more and 40 mm or less. The widths of the first and second side core parts 33, 34 are equivalent to the width Ws₁ of the tip surface 3af. The size of each core part is related to a magnitude of a magnetic path area of the magnetic core 3.

(Miscellaneous)

The reactor 1 may include at least one of a case, an adhesive layer, a holding member and a molded resin portion as another component. The case is a member for accommodating an assembly of the coil 2 and the magnetic core 3 inside. The assembly accommodated in the case may be embedded by a sealing resin portion. The adhesive layer fixes the assembly to a placing surface, fixes the assembly to the inner bottom surface of the case and fixes the case to the placing surface or the like. The holding member is interposed between the coil 2 and the magnetic core 3 to ensure electrical insulation between the coil 2 and the magnetic core 3. The molded resin portion integrates the coil 2 and the magnetic core 3 by covering the outer periphery of the assembly.

[Functions and Effects]

The reactor 1 of the first embodiment can be reduced in weight. This is because the width Ws₂ of the facing surface 3bf of the second core 3b is shorter than the width Ws₁ of the tip surface 3af of the first core 3a. Since the width Ws₂ of the facing surface 3b is shorter than the width Ws₁ of the tip surface 3af, the width W₃₂ of the second end core part 32 becomes shorter than the width W₃₁ of the first end core part 31 as compared to the case where the width Ws₂ of the facing surface 3bf and the width Ws₁ of the tip surface 3af are equal. That is, the volume of the second core 3b is reduced. Thus, the weight of the second core 3b is reduced, wherefore the magnetic core 3 can be reduced in weight.

Further, the reactor 1 can maintain the electromagnetic performance such as an inductance. This is because the relative magnetic permeability μs₂ of the second core 3b is higher than the relative magnetic permeability μs₁ of the first core 3a. Since the relative magnetic permeability μs₂ of the second core 3b is higher than the relative magnetic permeability μs₁ of the first core 3a, a magnetic flux which can pass between the tip surface 3af and the facing surface 3bf is easily balanced even if the width Ws₂ of the facing surface 3b is shorter than the width Ws₁ of the tip surface 3af. That is, a balance of the magnetic flux can be substantially maintained between the first and second cores 3a, 3b, and a reduction in inductance can be suppressed. Thus, the width Ws₂ of the facing surface 3bf can be made shorter while the inductance is maintained.

Particularly, the reactor 1 easily realizes a weight reduction while maintaining the electromagnetic performance since a ratio of the width Ws₂ of the facing surface 3bf to the width Ws₁ of the tip surface 3af is in a specific range and a ratio of the relative magnetic permeability μs₂ of the second core 3b to the relative magnetic permeability μr₁ of the first core 3a is in a specific range. Further, the relative magnetic permeability μr₁ and the width Ws₁, and the relative magnetic permeability μs₂ and the width Ws₂ satisfy the specific relationship, whereby a reduction in inductance can be effectively suppressed.

Since the first core 3a is constituted by the compact of the composite material and the second core 3b is constituted by the powder compact, the relative magnetic permeabilities of the first and second cores 3a, 3b are respectively easily set in the predetermined ranges in the reactor 1. Further, if the first core 3a is constituted by the compact of the composite material and the second core 3b is constituted by the powder compact, a predetermined inductance is easily obtained even if the magnetic core 3 is not provided with the gap part.

### SECOND EMBODIMENT

A reactor 1 of the second embodiment is described with reference to FIG. 5. The reactor 1 of the second embodiment differs from the reactor 1 of the first embodiment in that a magnetic core 3 is of an E-I type. The following description is centered on points of difference from the first embodiment. Components similar to those of the first embodiment may not be described.

A first core 3a includes a first end core part 31, an entire middle core part 30 and entire first and second side core parts 33, 34. The middle core part 30 extends in the X direction toward a second end core part 32 from an intermediate part in the Y direction of the first end core part 31. The first core 3a is E-shaped. The first core 3a is a compact of a composite material.

The second core 3b includes only the second end core part 32. The second core 3b does not include the middle core part 30 and the first and second side core parts 33, 34. The second core 3b is I-shaped. The second core 3b is a powder compact.

In this embodiment, an end part of the middle core part 30 on the side of the second end core part 32 is in contact with the second end core part 32. Thus, there is substantially no clearance between the middle core part 30 and the second end core part 32 and a gap part is not present. Unlike this embodiment, a gap part can be provided between the middle core part 30 and the second end core part 32. In the case of providing the gap part between the middle core part 30 and the second end core part 32, the middle core part 30 is shorter than the both side core parts 33, 34. In this way, a clearance serving as the gap part can be provided between the middle core part 30 and the second end core part 32.

A positional relationship of a facing surface 3bf and a tip surface 3af, a relationship of a width Ws₂ of the facing surface 3bf and a width Ws₁ of the tip surface 3af and a relationship of a relative magnetic permeability μs₁ of the first core 3a and a relative magnetic permeability μs₂ of the second core 3b are the same as in the first embodiment. As in the first embodiment, the relative magnetic permeability μs₁ and the width Ws₁, and the relative magnetic permeability μs₂ and the width Ws₂ satisfy the above relational expression. That is, {(μr₁×Ws₁)/(μr₂×Ws₂)} is 0.1 or more and 1.6 or less.

[Functions and Effects]

The reactor 1 of the second embodiment can be reduced in weight while an inductance is maintained similarly to the reactor 1 of the first embodiment.

### THIRD EMBODIMENT

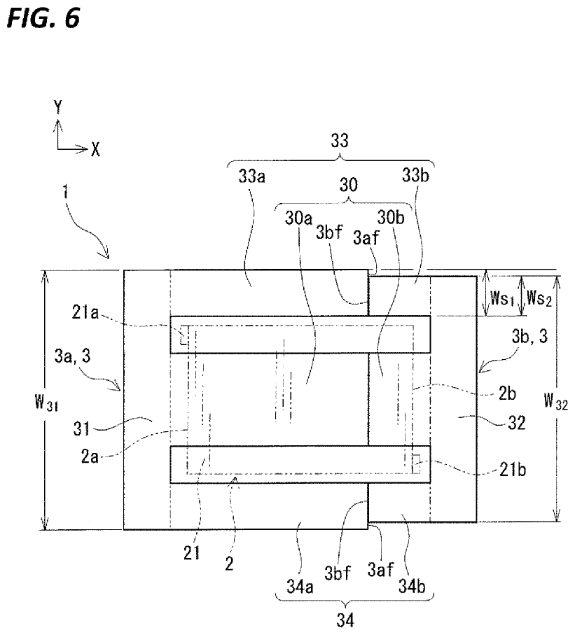

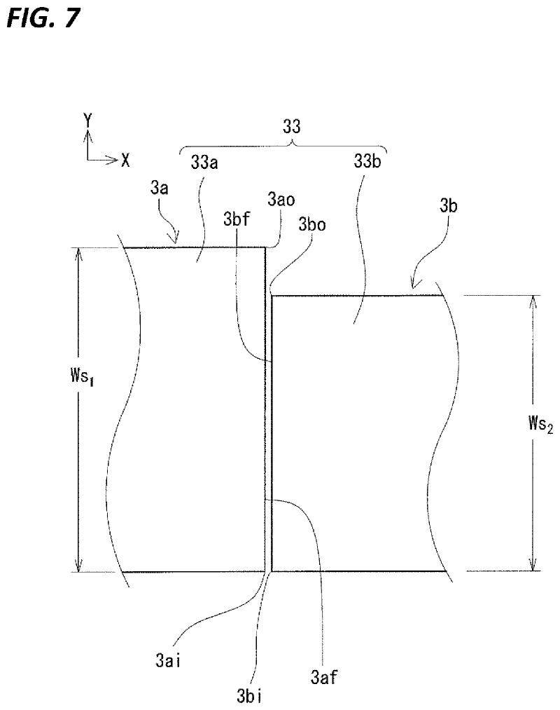

A reactor 1 of the third embodiment is described with reference to FIGS. 6 and 7. The reactor 1 of the third embodiment differs from the reactor 1 of the first embodiment in that a magnetic core 3 is of an E-E type. The following description is centered on points of difference from the first embodiment. Components similar to those of the first embodiment may not be described. FIG. 7 is an enlarged view of the vicinity of a tip surface 3af and a facing surface 3bf on the side of a first side core part 33 when viewed from the Z direction. Although only the side of the first side core part 33 is shown in FIG. 7, the side of a second side core part 34 shown in FIG. 6 also has a similar configuration. Further, although the tip surface 3af and the facing surface 3bf are shown to be separated for the convenience of description in FIG. 7, these surfaces are actually in contact.

Each of the first and second side core parts 33, 34 of this embodiment is divided into two in the X direction as shown in FIG. 6. The first side core part 33 includes a first part 33a and a second part 33b. The second side core part 34 includes a first part 34a and a second part 34b. The first part 33a, 34a is located on one side in the X direction of each side core part 33, 34, specifically, on the side of a first end core part 31. The second part 33b, 34b is located on the other side in the X direction of each side core part 33, 34, specifically, on the side of a second end core part 32. In this embodiment, widths of the second parts 33b, 34b are shorter than those of the first parts 33a, 34a. The respective widths of the first parts 33a, 34a are equal. The respective widths of the second parts 33b, 34b are equal. Further, a total width of the first parts 33a, 34a is equal to a width of a middle core part 30.

The first parts 33a, 34a and the second parts 33b, 34b are in contact, and there is substantially no clearance between the first parts 33a, 34a and the second parts 33b, 34b. That is, the both side core parts 33, 34 include no gap part between the first parts 33a, 34a and the second parts 33b, 34b. A length of each of the first parts 33a, 34a and the second parts 33b, 34b may be appropriately set to obtain predetermined magnetic properties. The first parts 33a, 34a may be longer or shorter than the second parts 33b, 34b. Further, the respective lengths of the first parts 33a, 34a may be equal or different. The respective lengths of the second parts 33b, 34b may be equal or different. In this embodiment, the first parts 33a, 34a are longer than the second parts 33b, 34b. Further, the respective lengths of the first parts 33a, 34a are equal. The respective lengths of the second parts 33b, 34b are equal.

As shown in FIG. 6, a first core 3a includes the first end core part 31, a first middle core part 30a and the first parts 33a, 34a, which are parts of the first and second side core parts 33, 34. The first end core part 31, the first middle core part 30a and the first parts 33a, 34a of the both side core parts 33, 34 are integrally molded. The first parts 33a, 34a extend in the X direction toward the second parts 33b, 34b from both end parts in the Y direction of the first end core part 31. The first core 3a is E-shaped when viewed from the Z direction. The first core 3a is a compact of a composite material.

Each of the first parts 33a, 34a in the both side core parts 33, 34 of the first core 3a has the tip surface 3af facing the second core 3b as shown in FIG. 6. A width Ws₁ of the tip surface 3af is equal to the widths of the first parts 33a, 34a.

A second core 3b includes the second end core part 32, a second middle core part 30b and the second parts 33b, 34b, which are remaining parts of the first and second side core parts 33, 34. The second end core part 32, the second middle core part 30b and the second parts 33b, 34b of the both side core parts 33, 34 are integrally molded. The second parts 33b, 34b extend in the X direction toward the first parts 33a, 34a from both end parts in the Y direction of the second end core part 32. The second core 3b is E-shaped when viewed from the Z direction. The second core 3b is a powder compact.

In this embodiment, the facing surface 3bf is provided on the second part 33b, 34b of each of the first and second side core parts 33, 34. A width Ws₂ of the facing surface 3bf of this embodiment is equal to the widths of the second parts 33b, 34b.

The tip surface 3af and the facing surface 3bf satisfy a specific positional relationship as in the first embodiment. Specifically, as shown in FIG. 7, an outer side edge 3bo of the facing surface 3bf is located inwardly of an outer side edge 3ao of the tip surface 3af in the Y direction, and an inner side edge 3bi of the facing surface 3bf and an inner side edge 3ai of the tip surface 3af are substantially aligned in the Y direction.

Further, as in the first embodiment, the width Ws₂ of the facing surface 3bf is shorter than the width Ws₁ of the tip surface 3af. In this embodiment, outer parts in the Y direction of the first parts 33a, 34a project further outward than the second parts 33b, 34b when viewed from the Z direction as shown in FIG. 6. Thus, a width W₃₂ of the second end core part 32 is shorter than a width W₃₁ of the first end core part 31.

A relationship of a relative magnetic permeability μs₁ of the first core 3a and a relative magnetic permeability μs₂ of the second core 3b is the same as in the first embodiment. Further, as in the first embodiment, the relative magnetic permeability psi and the width Ws₁, and the relative magnetic permeability μs₂ and the width Ws₂ satisfy the above relational expression. That is, {(μr₁×Ws₁)/(μr₂×Ws₂)} is 0.1 or more and 1.6 or less.

[Functions and Effects]

The reactor 1 of the third embodiment can be reduced in weight while an inductance is maintained similarly to the reactor 1 of the first embodiment.

### FOURTH EMBODIMENT

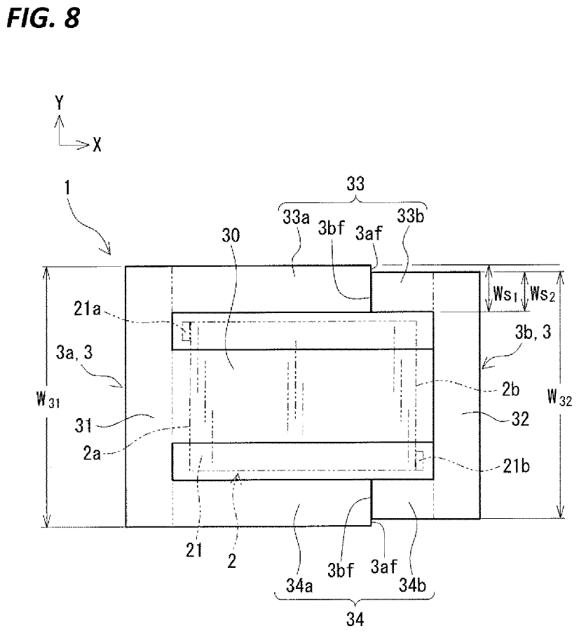

A reactor 1 of the fourth embodiment is described with reference to FIG. 8. The reactor 1 of the fourth embodiment differs from the reactor 1 of the third embodiment in that a magnetic core 3 is of an E-U type. The following description is centered on points of difference from the third embodiment. Components similar to those of the third embodiment may not be described.

A first core 3a includes a first end core part 31, an entire middle core part 30 and first parts 33a, 34a of first and second side core parts 33, 34. The first core 3a is E-shaped. The first core 3a is a compact of a composite material.

A second core 3b includes the first end core part 31, second parts 33b, 34b of the first and second side core parts 33, 34. The second core 3b does not include the middle core part 30. The second core 3b is U-shaped. The second core 3b is a powder compact.

In this embodiment, an end part of the middle core part 30 on the side of the second end core part 32 is in contact with the second end core part 32. Thus, there is substantially no clearance between the middle core part 30 and the second end core part 32 and a gap part is not present. It is also possible to provide a gap part between the middle core part 30 and the second end core part 32 as in the second embodiment.

A positional relationship of a facing surface 3bf and a tip surface 3af, a relationship of a width Ws₂ of the facing surface 3bf and a width Ws₁ of the tip surface 3af and a relationship of a relative magnetic permeability μs₁ of the first core 3a and a relative magnetic permeability μs₂ of the second core 3b are the same as in the third embodiment. As in the first embodiment, the relative magnetic permeability μs₁ and the width Ws₁, and the elative magnetic permeability μs₂ and the width Ws₂ satisfy the above relational expression. That is, {(μr₁×Ws₁)/(μr₂×Ws₂)} is 0.1 or more and 1.6 or less.

[Functions and Effects]

The reactor 1 of the fourth embodiment can be reduced in weight while an inductance is maintained similarly to the reactor 1 of the first embodiment.

### FIFTH EMBODIMENT

[Converter, Power Conversion Device]

The reactors 1 of the first to fourth embodiments can be used in an application satisfying the following energizing conditions. The energizing conditions include, for example, a maximum direct current of about 100 A or more and 1000 A or less, an average voltage of about 100 V or more and 1000 V or less and a use frequency of about 5 kHz or more and 100 kHz or less. The reactor 1 of the first to fourth embodiments can be typically used as a constituent component of a converter to be installed in a vehicle such as an electric or hybrid vehicle and a constituent component of a power conversion device provided with this converter.

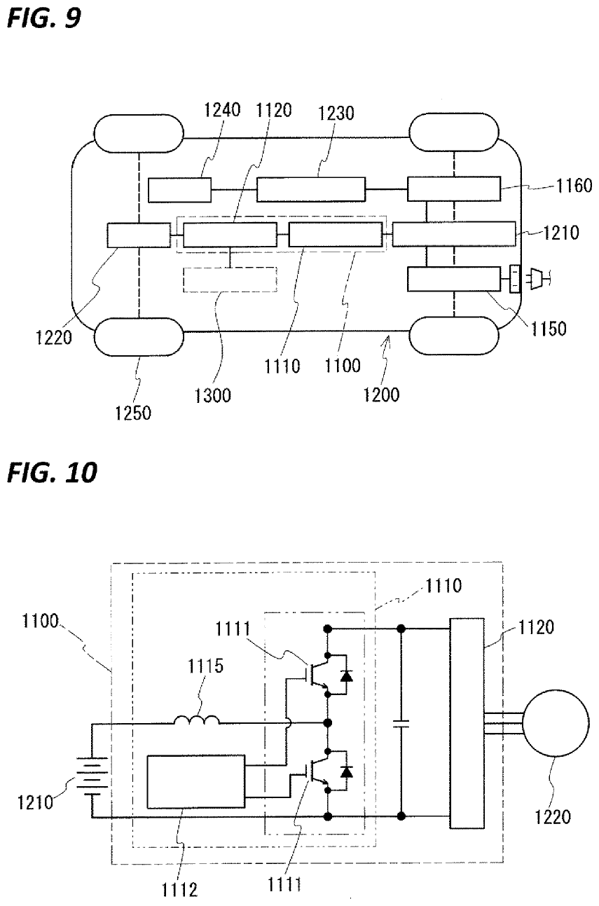

A vehicle 1200 such as a hybrid or electric vehicle is, as shown in FIG. 9, provided with a main battery 1210, a power conversion device 1100 connected to the main body 1210 and a motor 1220 used for travel by being driven by power supplied from the main body 1210. The motor 1220 is, typically, a three-phase alternating current motor and has a function of driving wheels 1250 during travel and a function as a generator during regeneration. In the case of a hybrid vehicle, the vehicle 1200 includes an engine 1300 in addition to the motor 1220. FIG. 9 shows an inlet as a charging point of the vehicle 1200, but the vehicle 1200 can include a plug.

The power conversion device 1100 includes a converter 1110 to be connected to the main battery 1210 and an inverter 1120 connected to the converter 1110 for the mutual conversion of a direct current and an alternating current. The converter 1110 shown in this example steps up an input voltage of the main battery 1210 of about 200 V or more and 300 V or less to about 400 V or more and 700 V or less and supplies the stepped-up voltage to the inverter 1120 during the travel of the vehicle 1200. The converter 1110 steps down an input voltage output from the motor 1220 via the inverter 1120 to a direct-current voltage suitable for the main battery 1210 and charges the direct-current voltage to the main battery 1210 during regeneration. The input voltage is a direct-current voltage. The inverter 1120 converts the direct current stepped up by the converter 1110 into a predetermined alternating current and supplies the converted current to the motor 1220 during the travel of the vehicle 1200 and converts an alternating current from the motor 1220 into a direct current and outputs the direct current to the converter 1110 during regeneration.

The converter 1110 includes a plurality of switching elements 1111, a drive circuit 1112 for controlling the operation of the switching elements 1111 and a reactor 1115 as shown in FIG. 10, and converts an input voltage by being repeatedly turned on and off. The conversion of the input voltage means voltage step-up and -down here. A power device such as a field effect transistor or an insulated gate bipolar transistor is used as the switching element 1111. The reactor 1115 has a function of smoothing a change of a current when the current is increased or decreased by a switching operation, using a property of a coil to hinder a change of a current flowing into a circuit. The reactor 1 of any one of the first to fourth embodiments is provided as the reactor 1115. By including the light-weight reactor 1, the power conversion device 1100 and the converter 1110 can be reduced in weight.

Besides the converter 1110, the vehicle 1200 is provided with a power supply device converter 1150 connected to the main battery 1210 and an auxiliary power supply converter 1160 connected to a sub-battery 1230 serving as a power source of auxiliary devices and the main battery 1210 and configured to convert a high voltage of the main battery 1210 into a low voltage. The converter 1110 typically performs DC-DC conversion, but the power supply device converter 1150 and the auxiliary power supply converter 1160 perform AC-DC conversion. The power supply device converter 1150 may perform DC-DC conversion. Reactors configured similarly to the reactor 1 of any one of the first to fourth embodiments and appropriately changed in size, shape and the like can be used as reactors of the power supply device converter 1150 and the auxiliary power supply converter 1160. Further, the reactor 1 of any one of the first to fourth embodiments can also be used as a converter for converting input power and only stepping up or only stepping down a voltage.

### TEST EXAMPLE 1

An influence on electromagnetic performance and a magnetic core weight reduction effect were evaluated for a reactor configured similarly to that of the first embodiment described above. A sample of the reactor used in Test Example 1 includes a magnetic core 3 of an E-T type. A relative magnetic permeability μs₁ of a first core 3a is 20. A relative magnetic permeability μr₂ of a second core 3b is 150.

In Test Example 1, Sample No. 1-1 in which a width Ws₂ of a facing surface 3bf was shorter than a width Ws₁ of a tip surface 3af and Sample No. 10 in which a width Ws₂ of a facing surface 3bf and a width Ws₁ of a tip surface 3af were equal were evaluated. The sizes of the magnetic core 3 and each main part are shown below.

(Size of Magnetic Core)
Length L of magnetic core 3: 70 mm
Width W of magnetic core 3=width W₃₁ of first end core part 31: 75 mm
Height H of magnetic core 3: 30 mm
Width of middle core part 30=widths of first and second middle core parts 30a, 30b: 24 mm
Lengths of first and second end core parts 31, 32: 12.5 mm
Widths of first and second side core parts 33, 34=width Ws₁ of tip surface 3af: 12 mm

<Sample No. 10>
Width Ws₂ of facing surface 3bf: 12 mm
Width W₃₂ of second end core part 32: 75 mm
Difference (Ws₁−Ws₂) between widths Ws₁ and Ws₂: 0 mm
Ratio (Ws₂/Ws₁) of width Ws₂ to width Ws₁: 100%<

<Sample No. 1-1>
Width Ws₂ of facing surface 3bf: 10 mm
Width W₃₂ of second end core part 32: 71 mm
Difference (Ws₁−Ws₂) between widths Ws₁ and Ws₂: 2 mm
Ratio (Ws₂/Ws₁) of width Ws₂ to width Ws₁: 83%

In Sample No. 10, the width W₃₂ of the second end core part 32 is 75 mm equal to the width W₃₁ of the first end core part 31. Sample No. 10 is a comparison model. In Sample No. 1-1, the width Ws₂ of the facing surface 3bf is shorter than the width Ws₁ of the tip surface 3af by 2 mm

(Evaluation of Electromagnetic Performance)

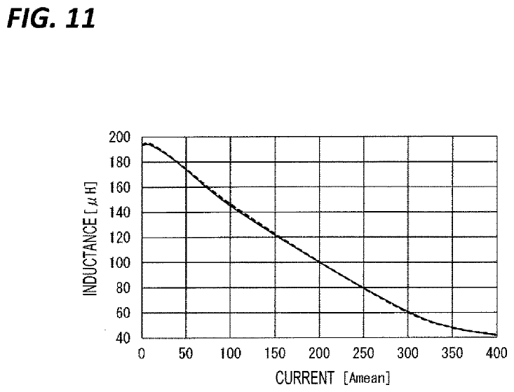

An inductance and a loss were analyzed by computer simulation for the reactor of each sample. JMAG-Designer 19.0 produced by JSOL Corporation, which is a commercially available electromagnetic field analysis software, was used for analysis. For the analysis of the inductance, an inductance when a direct current was caused to flow in a coil was obtained. A current was varied in a range of 0 A to 400 A. Inductances when a current value was 0 A, 100 A, 200 A and 300 A are shown in Table 1. In Table 1, the inductance at each current value in Sample No. 1-1 is shown as a ratio of difference from the inductance at each current value in Sample No. 10. This ratio is shown in percentage with the inductance at each current value in Sample No. 10 set at 100. Further, a graph of inductance obtained by the analysis is shown in FIG. 11. A horizontal axis represents a current (Amean) in the graph of FIG. 11. A vertical axis represents an inductance (μH) in the graph of FIG. 11. In FIG. 11, a broken-line graph curve represents an inductance of Sample No. 10. In FIG. 11, a solid-line graph curve represents an inductance of Sample No. 1-1.

In the analysis of the loss, a total loss was obtained when the reactor was driven under conditions including a direct current of 0 A, an input voltage of 300 V, an output voltage of 600 V and a frequency of 20 kHz. The total loss includes an iron loss of the magnetic core, a loss in the coil and the like. A result of that is shown in Table 1. In Table 1, the total loss of Sample No. 1-1 is shown as a ratio of difference from the total loss of Sample No. 10. This ratio is shown in percentage with the loss of Sample No. 10 set to 100.

(Evaluation of Weight Reduction Effect)

A reduction amount of the volume of the second core in Sample No. 1-1 from the volume of the second core in Sample No. 10 was calculated. A volume reduction amount is obtained by subtracting the volume of the second core of Sample No. 1-1 from that of the second core of Sample No. 10. A result of that is shown in Table 1. Further, a mass ratio of the second core of Sample No. 1-1 to the second core of Sample No. 10 was calculated. The mass ratio shows a ratio of the mass of the second core of Sample No. 1-1 to that of the second core of Sample No. 10 in percentage. The mass ratio is also shown in Table 1.

TABLE 1

Sample No.

| | | | |
|---|---|---|---|
| Item | Unit | 10 | 1-1 |

| Ws₁ − Ws₂ | | mm | 0 | 2 |
|---|---|---|---|---|
| Ws₂/Ws₁ | | % | 100 | 83 |
| Inductance | 0 A | % | — | −1.0 |
| | 100 A | | — | −0.9 |
| | 200 A | | — | −0.2 |
| | 300 A | | — | +0.9 |

| | | | |
|---|---|---|---|
| Total Loss | % | — | −0.3 |
| Volume Reduction Amount | mm³ | — | 1500 |
| Mass Ratio | % | — | 96 |

As shown in Table 1 and FIG. 11, an inductance characteristic of Sample No. 1-1 is substantially the same as that of Sample No. 10. Specifically, as shown in Table 1, the inductance at each current value of 0 A to 300 A in Sample No. 1-1 is within ±2.5%, further within ±2.0% and particularly within ±1.0% of the inductance at each current value in Sample No. 10. Thus, Sample No. 1-1 can be said to have the inductance characteristic equivalent to that of Sample No. 10. That is, Sample No. 1-1 can sufficiently maintain a predetermined inductance. Thus, in Sample No. 1-1, an influence given to the inductance by making the width of the facing surface shorter than that of the tip surface is minor. Further, results of Table 1 show that the loss of Sample No. 1-1 is hardly different from that of Sample No. 10 or rather slightly reduced.

Further, Sample No. 1-1 can reduce the weight of the second core by 4% as compared to Sample No. 10.

### TEST EXAMPLE 2

In Test Example 2, an influence on electromagnetic performance given by a reduction amount of the width Ws₂ of the facing surface 3bf from the width Ws₁ of the tip surface 3af was examined while changing the width Ws₂. Specifically, evaluations similar to those of Test Example 1 were conducted for reactors of Samples No. 2-1 to No. 2-5 in which the width Ws₂ of the facing surface 3bf was made shorter than the width Ws₁ of the tip surface 3af in a range of 1 mm to 5 mm Sample No. 2-2 is the same as Sample No. 1-1 of Test Example 1. Samples No. 2-1 to No. 2-5 are different only in the width Ws₂ of the facing surface 3bf. A difference (Ws₁−Ws₂) between the widths Ws₁ and Ws₂ in each sample and a ratio (Ws₂/Ws₁) of the width Ws₂ to the width Ws₁ are respectively shown in Table 2.

An inductance and a total loss were obtained in the same manner as in Test Example 1 for the reactor of each sample. A result of that is shown in Table 2. In Table 2, the inductances at each current value in Samples No. 2-1 to No. 2-5 are shown as ratios of difference from the inductance at each current value in Sample No. 10. The total losses of Samples No. 2-1 to No. 2-5 are shown as ratios of difference from the total loss of Sample No. 10. Further, as in Test Example 1, volume reduction amounts and mass ratios of the second cores in Samples No. 2-1 to No. 2-5 from and to the second core in Sample No. 10 are shown in Table 2.

TABLE 2

| | | | Sample No. | | | | | |
|---|---|---|---|---|---|---|---|---|
| Item | | Unit | 10 | 2-1 | 2-2 | 2-3 | 2-4 | 2-5 |
| Ws₁-Ws₂ | | mm | 0 | 1 | 2 | 3 | 4 | 5 |
| Ws₂/Ws₁ | | % | 100 | 92 | 83 | 75 | 67 | 58 |
| Inductance | 0 A | % | — | −0.4 | −1.0 | −1.6 | −2.5 | −3.6 |
| | 100 A | | — | −0.4 | −0.9 | −1.5 | −2.3 | −3.4 |
| | 200 A | | — | 0.0 | 0.2 | 0.3 | −0.4 | −0.4 |
| | 300 A | | — | +0.4 | +0.9 | +1.5 | +2.5 | +3.7 |

| | | | | | | | |
|---|---|---|---|---|---|---|---|
| Total Loss | % | — | −0.1 | −0.3 | −0.5 | −0.6 | −0.6 |
| Volume Reduction Amount | mm³ | — | 750 | 1500 | 2250 | 3000 | 3750 |
| Mass Ratio | % | — | 98 | 96 | 94 | 92 | 90 |

As shown in Table 2, the volume reduction amount of the second core increases as the width Ws₂ of the facing surface 3bf becomes shorter than the width Ws₁ of the tip surface 3af, i.e. as the difference (Ws₁−Ws₂) between the width Ws₁ of the tip surface and the width Ws₂ of the facing surface becomes larger. That is, the weight reduction effect increases. However, if the width Ws₂ of the facing surface becomes even shorter, the deterioration of the inductance characteristic accordingly becomes notable. Specifically, a variation from the inductance at each current value of 0 A to 300 A in Sample No. 10 becomes larger. That is, it becomes difficult to maintain an inductance characteristic equivalent to that of Sample No. 10. As is understood from Table 2, as the width Ws₂ of the facing surface is made shorter, the volume reduction amount of the second core increases at a constant rate, whereas an inductance variation range becomes larger than an increasing rate of the volume reduction amount. Since a variation range from the inductance at each current value of 0 A to 300 A in Sample No. 10 is within ±2.5% in Samples No. 2-1 to No. 2-4, it can be said that a predetermined inductance characteristic is substantially maintained. Particularly, since the variation range from the inductance at each current value of 0 A to 300 A in Sample No. 10 is within ±2.0% in Samples No. 2-1 to No. 2-3, the predetermined inductance characteristic can be more satisfactorily maintained. From this, the ratio (Ws₂/Ws₁) of the width Ws₂ of the facing surface to the width Ws₁ of the tip surface is thought to be preferably 60% or more, further 70% or more. Further, if not only the weight reduction effect, but also a loss reduction effect is considered, the ratio (Ws₂/Ws₁) is thought to be preferably 92% or less, further 90% or less.

### TEST EXAMPLE 3

An influence on electromagnetic performance and a magnetic core weight reduction effect were evaluated for reactors configured similarly to that of the third embodiment described above. Samples of the reactors used in Test Example 3 include a magnetic core 3 of an E-E type. A relative magnetic permeability μs₁ of a first core 3a is 20. A relative magnetic permeability μr₂ of a second core 3b is 150.

In Test Example 3, Samples No. 3-1 to No. 3-5 in which a width Ws₂ of a facing surface 3bf was shorter than a width Ws₁ of a tip surface 3af and Sample No. 30 in which a width Ws₂ of a facing surface 3bf and a width Ws₁ of a tip surface 3af were equal were evaluated. In Samples No. 3-1 to No. 3-5, the width Ws₂ of the facing surface 3bf was made shorter than the width Ws₁ of the tip surface 3af in a range of 1 mm to 5 mm Samples No. 3-1 to No. 3-5 are different from Sample No. 30 only in the width Ws₂ of the facing surface 3bf. The sizes of the magnetic core 3 and each main part are shown below.

(Size of Magnetic Core)
Length L of magnetic core 3: 70 mm
Width W of magnetic core 3=width W₃₁ of first end core part 31: 75 mm
Height H of magnetic core 3: 30 mm
Width of middle core part 30=widths of first and second middle core parts 30a, 30b: 24 mm
Lengths of first and second end core parts 31, 32: 12.5 mm
Widths of first parts 33a, 34a of first and second side core parts 33, 34=width Ws₁ of tip surface 3af: 12 mm

<Sample No. 30>
Widths of second parts 33b, 34b of first and second side core parts 33, 34=width Ws₂ of facing surface 3bf: 12 mm
Width W₃₂ of second end core part 32: 75 mm
Difference (Ws₁−Ws₂) between widths Ws₁ and Ws₂: 0 mm
Ratio (Ws₂/Ws₁) of width Ws₂ to width Ws₁: 100%<

<Sample No. 3-1>
Width Ws₂ of facing surface 3bf: 11 mm
Width W₃₂ of second end core part 32: 73 mm
Difference (Ws₁−Ws₂) between widths Ws₁ and Ws₂: 1 mm
Ratio (Ws₂/Ws₁) of width Ws₂ to width Ws₁: 92%<

<Sample No. 3-2>
Width Ws₂ of facing surface 3bf: 10 mm
Width W₃₂ of second end core part 32: 71 mm
Difference (Ws₁−Ws₂) between widths Ws₁ and Ws₂: 2 mm
Ratio (Ws₂/Ws₁) of width Ws₂ to width Ws₁: 83%<

<Sample No. 3-3>
Width Ws₂ of facing surface 3bf: 9 mm
Width W₃₂ of second end core part 32: 69 mm
Difference (Ws₁−Ws₂) between widths Ws₁ and Ws₂: 3 mm
Ratio (Ws₂/Ws₁) of width Ws₂ to width Ws₁: 75%<

<Sample No. 3-4>
Width Ws₂ of facing surface 3bf: 8 mm
Width W₃₂ of second end core part 32: 67 mm
Difference (Ws₁−Ws₂) between widths Ws₁ and Ws₂: 4 mm
Ratio (Ws₂/Ws₁) of width Ws₂ to width Ws₁: 75%<

<Sample No. 3-5>
Width Ws₂ of facing surface 3bf: 71 mm
Width W₃₂ of second end core part 32: 65 mm
Difference (Ws₁−Ws₂) between widths Ws₁ and Ws₂: 5 mm
Ratio (Ws₂/Ws₁) of width Ws₂ to width Ws₁: 58%

An inductance was obtained in the same manner as in Test Example 1 for the reactor of each sample. A result of that is shown in Table 3. In Table 3, the inductances at each current value in Samples No. 3-1 to No. 3-5 are shown as ratios of difference from the inductance at each current value in Sample No. 30. Further, volume reduction amounts and mass ratios of the second cores in Samples No. 3-1 to No. 3-5 from and to the second core in Sample No. 30 are shown in Table 3.

TABLE 3

| | | | Sample No. | | | | | |
|---|---|---|---|---|---|---|---|---|
| Item | | Unit | 30 | 3-1 | 3-2 | 3-3 | 3-4 | 3-5 |
| Ws₁-Ws₂ | | mm | 0 | 1 | 2 | 3 | 4 | 5 |
| Ws₂/Ws₁ | | % | 100 | 92 | 83 | 75 | 67 | 58 |
| Inductance | 0 A | % | — | −0.5 | −1.1 1 | −1.9 | −2.9 | −4.2 |
| | 100 A | | — | −0.4 | −1.0 | −1.8 | −2.9 | −4.3 |
| | 200 A | | — | 0.0 | −0.2 | −0.4 | −0.5 | −0.5 |
| | 300 A | | — | +0.4 | +1.0 | +1.7 | +2.9 | +4.4 |

| | | | | | | | |
|---|---|---|---|---|---|---|---|
| Volume Reduction Amount | mm³ | — | 1230 | 2460 | 3690 | 4920 | 6150 |
| Mass Ratio | % | — | 97 | 94 | 91 | 88 | 85 |

As shown in Table 3, even if the magnetic core is of the E-E type, the volume reduction amount of the second core increases as the width Ws₂ of the facing surface 3bf becomes shorter than the width Ws₁ of the tip surface 3af as in the case of the E-T type of Test Example 2 described above. That is, the weight reduction effect increases. Further, in the sample of the E-E type, as the width Ws₂ of the facing surface 3bf becomes shorter, the volume reduction amount becomes larger than that of the sample of the E-T type shown in Table 2 of Test Example 2, but the deterioration of the inductance characteristic becomes more notable. Specifically, a variation from the inductance at each current value of 0 A to 300 A in Sample No. 30 becomes larger. That is, it becomes difficult to maintain the inductance characteristic equivalent to that of Sample No. 30. Since a variation range from the inductance at each current value of 0 A to 300 A in Sample No. 30 is within ±2.5% in Samples No. 3-1 to No. 3-3, it can be said that a predetermined inductance characteristic is substantially maintained. Particularly, since the variation range from the inductance in Sample No. 30 is within ±2.0% in Samples No. 3-1 and No. 3-2, the predetermined inductance characteristic can be more satisfactorily maintained. From this, the ratio (Ws₂/Ws₁) of the width Ws₂ of the facing surface to the width Ws₁ of the tip surface is thought to be preferably 70% or more, further 80% or more in the magnetic core of the E-E type. Further, if the weight reduction effect is considered, the ratio (Ws₂/Ws₁) is thought to be preferably 92% or less, further 90% or less.

Further, total losses were obtained in the same manner as in Test Example 1 for the reactors of Samples No. 3-1 to No. 3-5. The loss of each sample was comparable to the loss of Sample No. 30.

### LIST OF REFERENCE NUMERALS

1 reactor
2 coil
2a first end surface, 2b second end surface
21 winding portion, 21a, 21b end part
3 magnetic core
3a first core, 3b second core
30 middle core part
30a first middle core part, 31b second middle core part
31 first end core part, 32 second end core part
33 first side core part, 34 second side core part
33a, 34a first part, 33b, 34b second part
3af tip surface, 3bf facing surface
3ao, 3bo outer side edge
3ai, 3bi inner side edge
W, Ws₁, Ws₂, W₃₁, W₃₂ width
L length
H height
1100 power conversion device
1110 converter
1111 switching element
1112 drive circuit
1115 reactor
1120 inverter
1150 power supply device converter
1160 auxiliary power supply converter
1200 vehicle
1210 main battery
1220 motor
1230 sub-battery
1240 auxiliary devices
1250 wheel
1300 engine

1. A reactor, comprising:
a coil: and
a magnetic core,
the magnetic core including a first core and a second core formed into a θ shape by being combined in an X direction,
the first core including a first end core part, at least a part of a middle core part and at least parts of both side core parts including a first side core part and a second side core part,
the second core including a second end core part, a remaining part of the middle core part and remaining parts of the first and second side core parts,
the first end core part facing a first end surface of the coil,
the second end core part facing a second end surface of the coil,
the middle core part being arranged inside the coil,
the first and second side core parts being arranged outside the coil to sandwich the middle core part,
a relative magnetic permeability of the second core being higher than that of the first core,
each of the first and second side core parts of the first core having a tip surface facing the second core,
a surface of the second core having facing surfaces facing the tip surfaces,
an outer side edge of the facing surface being located inwardly of that of the tip surface in a Y direction and an inner side edge of the facing surface and that of the tip surface being substantially aligned in the Y direction when the magnetic core is viewed from a Z direction,
a width in the Y direction of the facing surface being shorter than that of the tip surface,
the X direction being a direction along an axial direction of the middle core part,
the Y direction being a parallel direction of the middle core part, the first side core part and the second side core part, and
the Z direction being a direction orthogonal to both the X direction and the Y direction.

2. The reactor of claim 1, wherein the width in the Y direction of the facing surface is 60% or more and 92% or less of that of the tip surface.

3. The reactor of claim 1, wherein:
the first core is a compact of a composite material, a soft magnetic powder being dispersed in a resin in the composite material, and
the second core is a powder compact made of a raw powder containing a soft magnetic powder.

4. The reactor of claim 1, wherein the relative magnetic permeability of the first core is 5 or more and 50 or less.

5. The reactor of claim 1, wherein the relative magnetic permeability of the second core is 50 or more and 500 or less.

6. The reactor of claim 1, wherein a ratio of the relative magnetic permeability of the second core to that of the first core is 1.1 or more and 12 or less.

7. The reactor of claim 1, wherein {(μr₁×Ws₁)/(μr₂×Ws₂)} satisfies a condition of being 0.1 or more and 1.6 or less, where μr₁ denotes the relative magnetic permeability of the first core, Ws₁ denotes the width in the Y direction of the tip surface, μr₂ denotes the relative magnetic permeability of the second core and Ws₂ denotes the width in the Y direction of the facing surface.

8. The reactor of claim 1, wherein:
the first core includes each of the first and second side core parts entirely, and
the facing surfaces are provided on the second end core part of the second core.

9. The reactor of claim 1, wherein:
the first core includes a part of each of the first and second side core parts, and
the facing surface is provided on the remaining part of each of the first and second side core parts of the second core.

10. A converter, comprising the reactor of claim 1.

11. A power conversion device, comprising the converter of claim 10.
